(19) United States
(12) Patent Application Publication
(10) Pub. No.: US 2019/0375124 A1
(43) Pub. Date: Dec. 12, 2019

(54) ADJUSTABLE DEVICE OF CIRCULARLY SLICING AND SHAPING FRUIT AND VEGETABLE WITH FILTER

(71) Applicant: Yuen Yu Kiko NG, Hong Kong (HK)

(72) Inventor: Yuen Yu Kiko NG, Hong Kong (HK)

(21) Appl. No.: 16/108,088

(22) Filed: Aug. 21, 2018

(30) Foreign Application Priority Data
Jun. 11, 2018 (CN) 201810596254.2

(51) Int. Cl. B26D 1/20; B26D 3/26; B26D 7/32

(52) U.S. Cl. CPC B26D 1/20; B26D 3/26; B26D 2001/0093; B26D 2210/02; B26D 7/32

(57) ABSTRACT

The invention relates to an adjustable device of circularly slicing and shaping fruit and vegetable with filter which includes a base with a frame, a water filtering mechanism, an adjustable cutter head, and a sliding pressing mechanism. The base is provided with an electric conveyor belt, a controller, a hopper, a cutter head mounting seat and a worktop. The water filtering mechanism includes a trough body, a mesh plate, a vibration motor, and a water outlet. The adjustable cutter head includes a plurality of sub-cutter heads. The sub-cutter head includes a cylinder, a first motor, blades, an adjusting rod, a guiding rod, a blade connecting member. The sliding pressing mechanism includes a cantilever, a sliding support block, an electric cylinder and an elastic pressure plate. The cantilever is provided with a rack and a baffle. The sliding support block is provided with a second motor and a first infrared distance sensor. The device of the invention has advantages of having simple and reasonable structure, being easy to use, with high degree of intelligence and versatility, safe and reliable, labor-saving, and having strong practicality, etc., which effectively solves the problem of existing slicing machines being inconvenient.

### FIELD OF THE INVENTION

The invention relates to food equipment. In particular, the invention relates to an adjustable device of circularly slicing and shaping fruit and vegetable with filter.

### BACKGROUND

Fruits and vegetables are daily necessities. When vegetables such as radishes, sweet potatoes, and kohlrabi, and fruits need to be sliced for further processing or storage, the traditional method is manually slicing. Manually slicing is not only inefficient, but also generates slices with uneven thickness, and requires intense labor. Manual operation of slicing is also dangerous. The existing machines of slicing fruit and vegetable with continuous feeding of fruits and vegetables, is not convenient, as blades need to be varied for different sliced thicknesses and shapes of fruits and vegetables. This is because the distance between the blades, and the angle between the blades and movement direction of fruits and vegetables are fixed for the existing machines. The blades of these slicing machines are often unidirectional, which means that when fruits and vegetables are very thick, a long cutting track will be required, or reciprocating motion of the fruits and vegetables on the blades will be required with compromising half inefficiency. In addition, such machines cannot filter the sliced fruits and vegetables. Additional manually filtering will be needed afterwards, which is not convenient.

### SUMMARY OF THE INVENTION

The technical problem to be solved is to overcome the above-mentioned deficiency by providing an adjustable device of circularly slicing and shaping fruit and vegetable with filter. It has advantages of having simple and reasonable structure, being easy to use, with high degree of intelligence and versatility, safe and reliable, labor-saving, and having strong practicality, etc., which effectively solves the problem of existing slicing machines being inconvenient.

The technical solution of the invention is to provide an adjustable device of circularly slicing and shaping fruit and vegetable with filter which includes a base with a frame, a water filtering mechanism, an adjustable cutter head, and a sliding pressing mechanism. One end of the base is provided with an electric conveyor belt and a controller. A hopper is arranged above the electric conveyor belt. The other end of the base is provided with a cutter head mounting seat and a work top.

The water filtering mechanism is a trough body having a U-shaped structure disposed under the cutter head mounting seat. The trough body is provided with a mesh plate, a vibration motor and a water outlet. One end of the trough body is hinged to the base, and the other end of the trough body is connected to the base through an elastic connecting member. The mesh plate and the bottom of the trough body form a cavity having a single opening, and the water outlet is connected to the cavity.

The adjustable cutter head includes a plurality of sub-cutter heads connected in a stack by a cutter head connecting piece. The sub-cutter head is connected with the cutter head mounting seat. The sub-cutter head includes a cylinder with double openings, a first motor disposed on the cylinder, blades with a long strip structure arranged in the same direction, adjusting rods disposed horizontally parallel to each other, a guiding rod disposed between the adjusting rods, and a blade connecting member. The adjusting rod and the guiding rod are arranged at the two ends of the blades and the two ends are respectively rotatably connected to the cylinder. The first motor is mutually connected with one end of the adjusting rod.

The adjusting rod is composed of a plurality of adjusting short rods. One end of the adjusting short rod is provided with a boring head, and the other end of the adjusting short rod is provided with a sleeve hole. The boring head and the sleeve hole of the adjacent adjusting short rods are sleeved with each other and they are bolted for fixation. The surfaces of the adjacent adjusting short rods are provided with an external thread with opposite rotation directions.

The sliding pressing mechanism includes a cantilever fixed to the base, a sliding support block slidably connected to the cantilever, an electric cylinder disposed on the sliding support block, and an elastic pressure plate connected to the electric cylinder. The cantilever is provided with a rack, a baffle. The sliding support block is provided with a second motor connected to the rack. The sliding support block is provided with a first infrared distance sensor that cooperates with the baffle. The elastic pressure plate includes a housing with a blind hole, a spring disposed in the housing, and a slider. The second infrared distance sensor is disposed on the housing. The slider is provided with a spike.

Further, the electric conveyor belt includes a plurality of rollers rotatably connected to the base and a conveyor belt disposed on the rollers. The rollers are mutually connected with a third motor disposed on the base.

Further, a buffer plate is disposed obliquely on the base between the electric conveyor belt and the adjustable cutter head.

Further, the sliding support block is a C-shaped structure, and the upper end of the sliding support block is provided with an inverted T-shaped slider. The T-shaped slider is snapped into the inverted T-shaped chute on the cantilever and is slidably connected thereto. The lower end of the sliding support block is slidably connected to a circular slide rail fixed on the cantilever.

Further, the elastic connecting member is a spring or an elastic band.

Further, the cutter head connecting member includes a first chuck and a second chuck which are sleeved with the first chuck. The first chuck and the second chuck are respectively engaged with the cylinders adjacent to each other. A first angle sensor and a pressure sensor are disposed at the junction of the first chuck and the second chuck. Two ends of the first angle sensor are respectively connected to the first chuck and the second chuck.

Further, the blade connecting member includes a third chuck engaged with one end of the blade, and a connecting block. The third chuck and the connecting block are sleeved to each other. A second angle sensor is disposed at the junction of the third chuck and the connecting block. The connecting block is provided with a connecting through hole.

Further, the connecting through hole and the adjusting rod are screwed to each other, and are slidably connected to the guiding rod.

Further, the controller is electrically connected to the worktop, the vibration motor, the first motor, the electric cylinder, the second motor, the first infrared distance sensor, the second infrared distance sensor, the third motor, the first angle sensor, and the second angle sensor, respectively.

The technical effect of the invention is to provide an adjustable device of circularly slicing and shaping fruit and vegetable with filter which includes a base with a frame, a water filtering mechanism, an adjustable cutter head, and a sliding pressing mechanism. The base is provided with an electric conveyor belt which conveys vegetables and fruit to the top of the adjustable cutter head. The sliding pressing mechanism drives the fruits and vegetables to reciprocatingly move on the adjustable cutter head for slicing. The adjustable cutter head adopts an intelligent and electric adjustable design, which can conveniently adjust parameters such as distance and angle between the blades, without manual replacement of the cutter head. The blades can be oriented in two directions, which will not reduce the slicing efficiency during the reciprocating movement of fruits and vegetables. The sliding pressing mechanism adopts an elastic design to avoid crushing fruits and vegetables. The sliced vegetable juice and liquid and the water for washing fruits and vegetables are separated and collected by the water filtering mechanism, which is convenient for subsequent processing or storage. The device of the invention has advantages of having simple and reasonable structure, being easy to use, with high degree of intelligence and versatility, safe and reliable, labor-saving, and having strong practicality, etc., which effectively solves the problem of existing slicing machines being inconvenient.

### BRIEF DESCRIPTION OF THE DRAWINGS

The invention is illustrated by the following figures and embodiments.

FIG. 1 shows a schematic diagram of whole structure of an adjustable device of circularly slicing and shaping fruit and vegetable with filter in accordance with an example embodiment.

FIG. 2 shows a schematic diagram of a base of an adjustable device of circularly slicing and shaping fruit and vegetable with filter in accordance with an example embodiment.

FIG. 3 shows a schematic diagram of a water filtering mechanism of an adjustable device of circularly slicing and shaping fruit and vegetable with filter in accordance with an example embodiment.

FIG. 4 shows a schematic diagram of an adjustable cutter head of an adjustable device of circularly slicing and shaping fruit and vegetable with filter in accordance with an example embodiment.

FIG. 5 shows an exploded diagram of an adjustable cutter head of an adjustable device of circularly slicing and shaping fruit and vegetable with filter in accordance with an example embodiment.

FIG. 6 shows a schematic diagram of an adjusting short rod of an adjustable device of circularly slicing and shaping fruit and vegetable with filter in accordance with an example embodiment.

FIG. 7 shows a schematic diagram of a cutter head connecting piece of an adjustable device of circularly slicing and shaping fruit and vegetable with filter in accordance with an example embodiment.

FIG. 8 shows a schematic diagram of a blade connecting member of an adjustable device of circularly slicing and shaping fruit and vegetable with filter in accordance with an example embodiment.

FIG. 9 shows a schematic diagram of a sliding pressing mechanism of an adjustable device of circularly slicing and shaping fruit and vegetable with filter in accordance with an example embodiment.

FIG. 10 shows a schematic diagram of an elastic pressure plate of an adjustable device of circularly slicing and shaping fruit and vegetable with filter in accordance with an example embodiment.

The reference numbers of the figures are as follows:

1: base; 11: electric conveyor belt; 111: conveyor belt; 112: roller; 113: third motor; 12: hopper; 13: controller; 14: elastic connecting member; 15: buffer plate; 16: cutter head mounting seat; 17: worktop; 2: water filtering mechanism; 21: trough body; 22: mesh plate; 23: vibration motor; 24: water outlet; 3: adjustable cutter head; 30: cylinder; 31: sub-cutter head; 32: cutter head connecting piece; 321: first chuck; 322: second chuck; 323: first angle sensor; 324: pressure sensor; 33: first motor; 34: blade; 35: blade connecting member; 351: third chuck; 352: connecting block; 353: second angle sensor; 354: connecting through hole; 36: adjusting rod; 361: adjusting short rod; 362: boring head; 363: sleeve hole; 37: guiding rod; 4: sliding pressing mechanism; 41: cantilever; 411: rack; 412: baffle; 42: sliding support block; 421: first infrared distance sensor; 43: electric cylinder; 44: elastic pressure plate; 441: housing; 442: spring; 443: slider; 444: second infrared distance sensor; 445: spike; 45: second motor.

### DETAILED DESCRIPTION

The invention is illustrated in accordance with figures. The figures as simplified diagrams demonstrate the basic structures of the apparatus of embodiments of the invention. Thus, the invention is not limited to the figures.

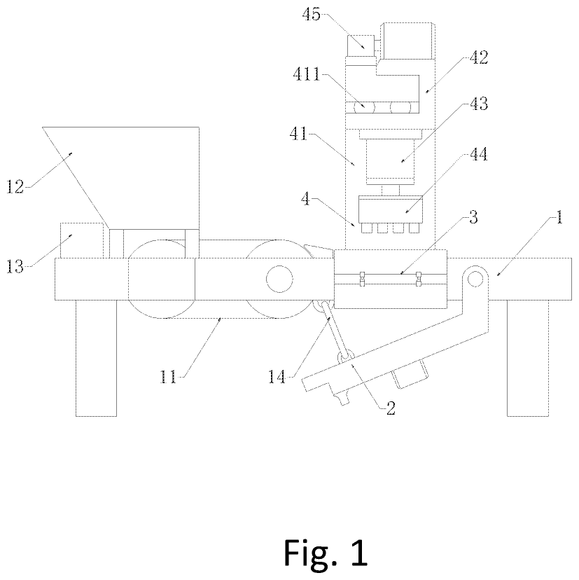

As shown in FIG. 1, an adjustable device of circularly slicing and shaping fruit and vegetable with filter includes a base 1 with a frame, a water filtering mechanism 2, an adjustable cutter head 3, and a sliding pressing mechanism 4.

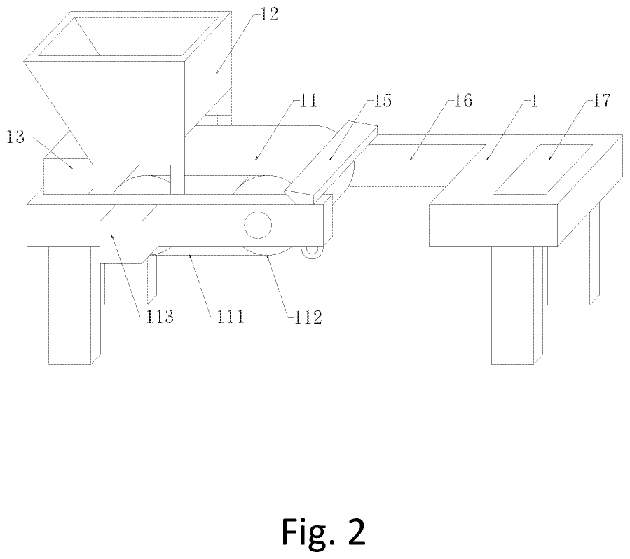

As show in FIG. 2, one end of the base 1 is provided with an electric conveyor belt 11 and a controller 13. A hopper 12 is arranged above the electric conveyor belt 11. The other end of the base 1 is provided with a cutter head mounting seat 16 and a work top 17.

In one example embodiment, the outlet of the hopper 12 is provided with an electric valve for controlling the conveying interval of the fruits and vegetables, and an infrared proximity switch is arranged on the electric conveyor belt 11 for monitoring the conveying speed of the fruits and vegetables. The conveying speed is controlled by the analysis of the controller 13 to avoid the fact that conveying too fact affects regular slicing work, and conveying too slowly affects slicing efficiency.

In one example embodiment, the cutter head mounting seat 16 is a hollowed area on the base 1, and the edge of the area is provided with a connecting member connected to the adjustable cutter head 3.

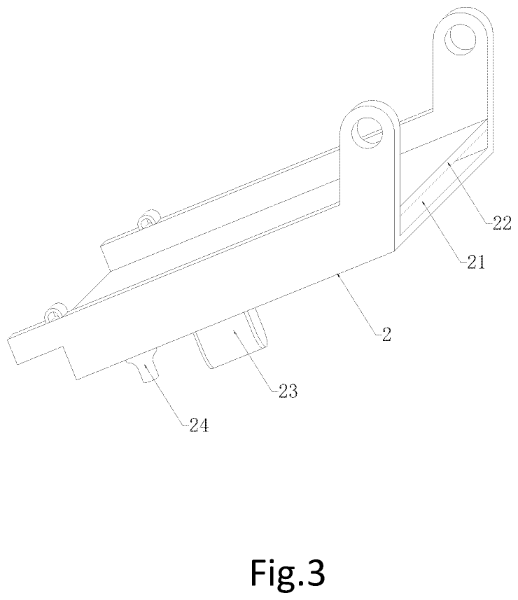

As shown in FIG. 3, the water filtering mechanism 2 is a trough body 21 having a U-shaped structure disposed under the cutter head mounting seat 16. The trough body 21 is provided with a mesh plate 22, a vibration motor 23 and a water outlet 24. One end of the trough body 21 is hinged to the base 1, and the other end of the trough body 21 is connected to the base 1 through an elastic connecting member 14. The mesh plate 22 divides the trough body 21 into two layers. The upper layer of the mesh plate 22 is used for guiding conveyance of the fruit and vegetable slices, and the lower layer of the mesh plate 22 and the bottom of the trough body 21 form a cavity having a single opening. The cavity is used for containing the filtered juice water. The single opening is provided for conveniently cleaning the cavity. The water outlet 24 is in communication with the cavity. The water outlet 24 should be connected with an external collecting mechanism to facilitate subsequent processing.

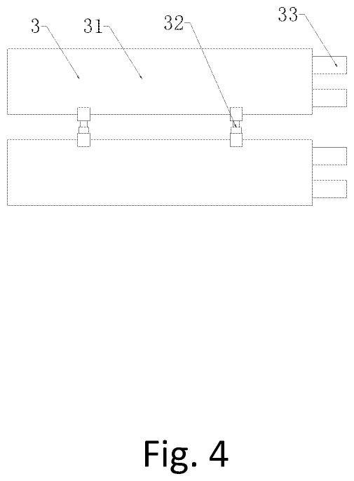

As shown in FIG. 4, the adjustable cutter head 3 includes a plurality of sub-cutter heads 31 connected in a stack by a cutter head connecting piece 32. The sub-cutter head 31 is connected with the cutter head mounting seat 16.

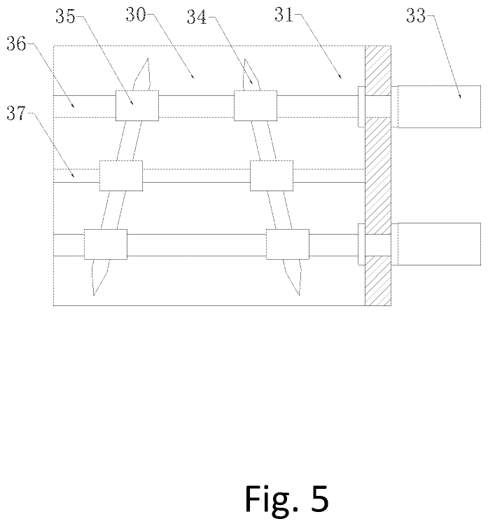

As shown in FIG. 5, the sub-cutter head 31 includes a cylinder 30 with double openings, a first motor 33 disposed on the cylinder 30, blades 34 with a long strip structure arranged in the same direction, adjusting rods 36 disposed horizontally parallel to each other, a guiding rod 37 disposed between the adjusting rods 36, and a blade connecting member 35. The adjusting rod 36 and the guiding rod 37 are arranged at the two ends of the blades 34 and the two ends are respectively rotatably connected to the cylinder 30. The first motor 33 is mutually connected with one end of the adjusting rod 36. In one example embodiment, the adjusting rod 36 and the guiding rod 37 are disposed only at both ends of the blades 34. In another example embodiment, the adjusting rod 36 and the guiding rod 37 are evenly disposed in the inner cavity of the cylinder 30 in a direction perpendicular to the blades 34, so that the various portions of the blades 34 are more evenly stressed.

The outer wall surface of the cylinder 30 should be provided with a connecting member for connecting with the cutter head mounting seat 16, such as a connecting plate with a connecting hole, a buckle, etc., and any element that can fixedly connect the cylinder 30 with the cutter head mounting seat 16. In a preferred embodiment, the top of the adjustable cutter head 3 should be substantially aligned with the upper surface of the cutter head mounting seat 16.

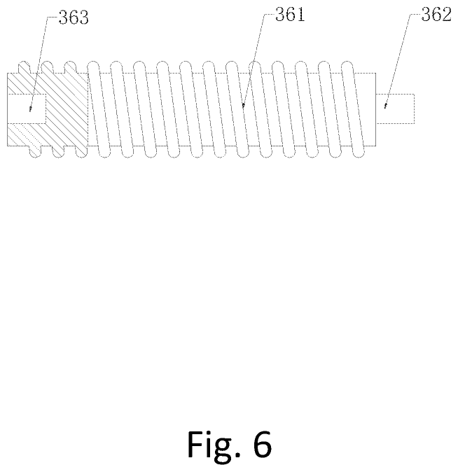

As shown in FIG. 6, the adjusting rod 36 is composed of a plurality of adjusting short rods 361. One end of the adjusting short rod 361 is provided with a boring head 362, and the other end of the adjusting short rod 361 is provided with a sleeve hole 363. The boring head 362 and the sleeve hole 363 of the adjacent adjusting short rods 361 are sleeved with each other and they are bolted for fixation. The surfaces of the adjacent adjusting short rods 361 are provided with an external thread with opposite rotation directions.

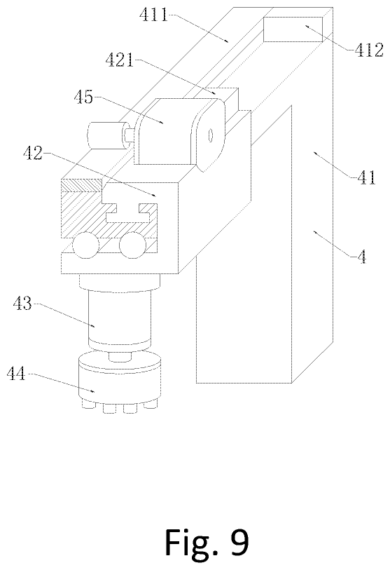

As shown in FIG. 9, the sliding pressing mechanism 4 includes a cantilever 41 fixed to the base 1, a sliding support block 42 slidably connected to the cantilever 41, an electric cylinder 43 disposed on the sliding support block 42, and an elastic pressure plate 44 connected to the electric cylinder 43. The cantilever 41 is provided with a rack 411, and a baffle 412. The sliding support block 42 is provided with a second motor 45 connected to the rack 411. The sliding support block 42 is provided with a first infrared distance sensor 421 that cooperates with the baffle 412. The second motor 45 is drivingly connected to the rack 411 to drive the sliding of the sliding support block 42 on the cantilever 41. The first infrared distance sensor 421 and the baffle 412 cooperate to measure the position information of the sliding support block 42. The controller 13 controls the reciprocal sliding of the sliding support block 42 on the cantilever 41.

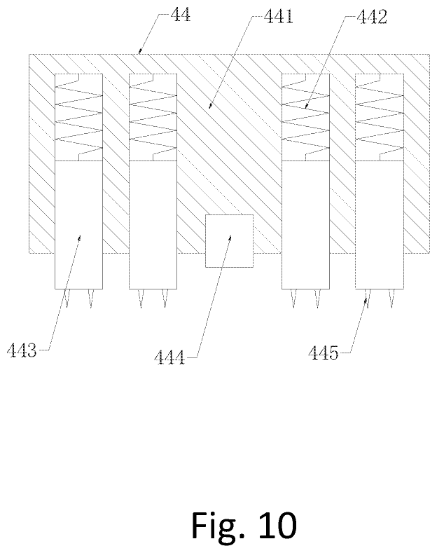

As shown in FIG. 10, the elastic pressure plate 44 includes a housing 441 with a blind hole, a spring 442 disposed in the housing 441, and a slider 443. The second infrared distance sensor 444 is disposed on the housing 441. The slider 443 is provided with a spike 445. The spring 442, the slider 443, and the spike 445 cooperate with each other to make the vegetables and fruits reciprocating move but not crushing the vegetables and fruits. The second infrared distance sensor 444 is used to detect the distance between the elastic pressure plate 44 and the blades 34, thereby avoiding the elastic pressure plate 44 pressing and breaking the blades 34.

In an example embodiment of FIG. 2, the electric conveyor belt 11 includes a plurality of rollers 112 rotatably connected to the base 1 and a conveyor belt 111 disposed on the rollers 112. The rollers 112 are mutually connected with a third motor 113 disposed on the base 1.

In an example embodiment of FIG. 2, a buffer plate 15 is disposed obliquely on the base 1 between the electric conveyor belt 11 and the adjustable cutter head 3. The upper surfaces of both ends of the buffer plate 15 are aligned with the tops of the electric conveyor belt 11 and the adjustable cutter head 3, respectively.

In an example embodiment of FIG. 9, the sliding support block 42 is a C-shaped structure, and the upper end of the sliding support block 42 is provided with an inverted T-shaped slider. The T-shaped slider is snapped into the inverted T-shaped chute on the cantilever 41 and is slidably connected thereto. The lower end of the sliding support block 42 is slidably connected to a circular slide rail fixed on the cantilever 41.

In an example embodiment, the elastic connecting member 14 is a spring or an elastic band, or any material or elements that can reduce the conveying vibration of the vibration motor 23 towards the base 1.

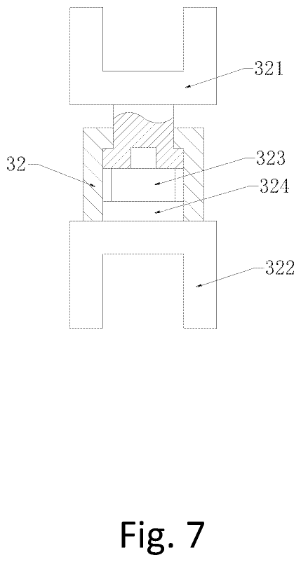

In an example embodiment of FIG. 7, the cutter head connecting member 32 includes a first chuck 321 and a second chuck 322 which are sleeved with the first chuck 321. The first chuck 321 and the second chuck 322 are respectively engaged with the cylinders 30 adjacent to each other. A first angle sensor 323 and a pressure sensor 324 are disposed at the junction of the first chuck 321 and the second chuck 322. Two ends of the first angle sensor 323 are respectively connected to the first chuck 321 and the second chuck 322. The first angle sensor 323 is used to monitor the relative rotation angle of the sub-cutter head 31. The controller 13 can display the sliced shape on the worktop 17 for reference by the user. The pressure sensor 324 is used to detect the positive pressure of the adjustable cutter head 3. The controller 13 determines whether the slicing work is normal. If the positive pressure is too large, it is necessary to alert the user and stop the slicing work.

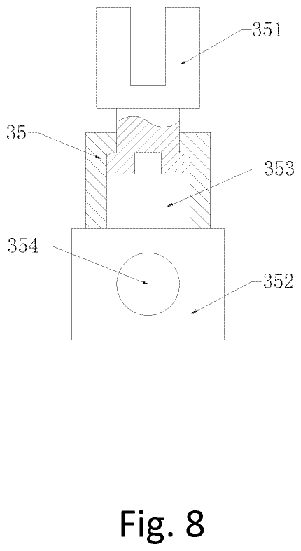

In an example embodiment of FIG. 8, the blade connecting member 35 includes a third chuck 351 engaged with one end of the blade 34, and a connecting block 352. The third chuck 351 and the connecting block 352 are sleeved to each other. A second angle sensor 353 is disposed at the junction of the third chuck 351 and the connecting block 352. The connecting block 352 is provided with a connecting through hole 354. The second angle sensor 353 is for detecting the rotation angle of the blade 34, and the controller 13 thereby adjusts the inclination angle of each of the blades 34.

In an example embodiment, the connecting through hole 354 and the adjusting rod 36 are screwed to each other, and are slidably connected to the guiding rod 37.

In an example embodiment, the controller 13 is electrically connected to the worktop 17, the vibration motor 23, the first motor 33, the electric cylinder 43, the second motor 45, the first infrared distance sensor 421, the second infrared distance sensor 444, the third motor 113, the first angle sensor 323, and the second angle sensor 353, respectively. The controller 13 coordinates the data processing of each sensor, and thereby controls the operations of the vibration motor 23, the first motor 33, the electric cylinder 43, the second motor 45, and the third motor 113.

An adjustable device of circularly slicing and shaping fruit and vegetable with filter of the invention includes a base with a frame, a water filtering mechanism, an adjustable cutter head, and a sliding pressing mechanism. The base is provided with an electric conveyor belt which conveys vegetables and fruit to the top of the adjustable cutter head. The sliding pressing mechanism drives the fruits and vegetables to reciprocatingly move on the adjustable cutter head for slicing. The adjustable cutter head adopts an intelligent and electric adjustable design, which can conveniently adjust parameters such as distance and angle between the blades, without manual replacement of the cutter head. The blades can be oriented in two directions, which will not reduce the slicing efficiency during the reciprocating movement of fruits and vegetables. The sliding pressing mechanism adopts an elastic design to avoid crushing fruits and vegetables. The sliced vegetable juice and liquid and the water for washing fruits and vegetables are separated and collected by the water filtering mechanism, which is convenient for subsequent processing or storage. The device of the invention has advantages of having simple and reasonable structure, being easy to use, with high degree of intelligence and versatility, safe and reliable, labor-saving, and having strong practicality, etc., which effectively solves the problem of existing slicing machines being inconvenient.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. An adjustable device of circularly slicing and shaping fruit and vegetable with filter, comprising: a base 1 with a frame, a water filtering mechanism 2, an adjustable cutter head 3, and a sliding pressing mechanism 4, wherein one end of the base 1 is provided with an electric conveyor belt 11 and a controller 13; a hopper 12 is arranged above the electric conveyor belt 11; the other end of the base 1 is provided with a cutter head mounting seat 16 and a work top 17,
wherein the water filtering mechanism 2 is a trough body 21 having a U-shaped structure disposed under the cutter head mounting seat 16; the trough body 21 is provided with a mesh plate 22, a vibration motor 23 and a water outlet 24; one end of the trough body 21 is hinged to the base 1, and the other end of the trough body 21 is connected to the base 1 through an elastic connecting member 14; the mesh plate 22 and the bottom of the trough body 21 form a cavity having a single opening; the water outlet 24 is in communication with the cavity,
wherein the adjustable cutter head 3 includes a plurality of sub-cutter heads 31 connected in a stack by a cutter head connecting piece 32; the sub-cutter head 31 is connected with the cutter head mounting seat 16; the sub-cutter head 31 includes a cylinder 30 with double openings, a first motor 33 disposed on the cylinder 30, blades 34 with a long strip structure arranged in the same direction, adjusting rods 36 disposed horizontally parallel to each other, a guiding rod 37 disposed between the adjusting rods 36, and a blade connecting member 35; the adjusting rod 36 and the guiding rod 37 are arranged at the two ends of the blades 34 and the two ends are respectively rotatably connected to the cylinder 30; the first motor 33 is mutually connected with one end of the adjusting rod 36,
wherein the adjusting rod 36 is composed of a plurality of adjusting short rods 361; one end of the adjusting short rod 361 is provided with a boring head 362, and the other end of the adjusting short rod 361 is provided with a sleeve hole 363; the boring head 362 and the sleeve hole 363 of the adjacent adjusting short rods 361 are sleeved with each other and they are bolted for fixation; the surfaces of the adjacent adjusting short rods 361 are provided with an external thread with opposite rotation directions,
wherein the sliding pressing mechanism 4 includes a cantilever 41 fixed to the base 1, a sliding support block 42 slidably connected to the cantilever 41, an electric cylinder 43 disposed on the sliding support block 42, and an elastic pressure plate 44 connected to the electric cylinder 43; the cantilever 41 is provided with a rack 411, and a baffle 412; the sliding support block 42 is provided with a second motor 45 connected to the rack 411; the sliding support block 42 is provided with a first infrared distance sensor 421 that cooperates with the baffle 412; the elastic pressure plate 44 includes a housing 441 with a blind hole, a spring 442 disposed in the housing 441, and a slider 443; the second infrared distance sensor 444 is disposed on the housing 441; the slider 443 is provided with a spike 445.

2. The adjustable device of circularly slicing and shaping fruit and vegetable with filter of claim 1, wherein the electric conveyor belt 11 includes a plurality of rollers 112 rotatably connected to the base 1 and a conveyor belt 111 disposed on the rollers 112; the rollers 112 are mutually connected with a third motor 113 disposed on the base 1.

3. The adjustable device of circularly slicing and shaping fruit and vegetable with filter of claim 1, wherein a buffer plate 15 is disposed obliquely on the base 1 between the electric conveyor belt 11 and the adjustable cutter head 3.

4. The adjustable device of circularly slicing and shaping fruit and vegetable with filter of claim 1, wherein the sliding support block 42 is a C-shaped structure, and the upper end of the sliding support block 42 is provided with an inverted T-shaped slider; the T-shaped slider is snapped into the inverted T-shaped chute on the cantilever 41 and is slidably connected thereto; the lower end of the sliding support block 42 is slidably connected to a circular slide rail fixed on the cantilever 41.

5. The adjustable device of circularly slicing and shaping fruit and vegetable with filter of claim 1, wherein the elastic connecting member 14 is a spring or an elastic band.

6. The adjustable device of circularly slicing and shaping fruit and vegetable with filter of claim 1, wherein the cutter head connecting member 32 includes a first chuck 321 and a second chuck 322 which are sleeved with the first chuck 321; the first chuck 321 and the second chuck 322 are respectively engaged with the cylinders 30 adjacent to each other; a first angle sensor 323 and a pressure sensor 324 are disposed at the junction of the first chuck 321 and the second chuck 322; two ends of the first angle sensor 323 are respectively connected to the first chuck 321 and the second chuck 322.

7. The adjustable device of circularly slicing and shaping fruit and vegetable with filter of claim 1, wherein the blade connecting member 35 includes a third chuck 351 engaged with one end of the blade 34, and a connecting block 352; the third chuck 351 and the connecting block 352 are sleeved to each other; a second angle sensor 353 is disposed at the junction of the third chuck 351 and the connecting block 352; the connecting block 352 is provided with a connecting through hole 354.

8. The adjustable device of circularly slicing and shaping fruit and vegetable with filter of claim 1, wherein the connecting through hole 354 and the adjusting rod 36 are screwed to each other, and are slidably connected to the guiding rod 37.

9. The adjustable device of circularly slicing and shaping fruit and vegetable with filter of claim 1, wherein the controller 13 is electrically connected to the worktop 17, the vibration motor 23, the first motor 33, the electric cylinder 43, the second motor 45, the first infrared distance sensor 421, the second infrared distance sensor 444, the third motor 113, the first angle sensor 323, and the second angle sensor 353, respectively; the controller 13 coordinates the data processing of each sensor, and thereby controls the operations of the vibration motor 23, the first motor 33, the electric cylinder 43, the second motor 45, and the third motor 113.
